(19) United States
(12) Patent Application Publication
(10) Pub. No.: US 2003/0053849 A1
(43) Pub. Date: Mar. 20, 2003

(54) Fastening binder ring mechanisms to binders

(75) Inventors: Chun Yuen To, Hong Kong (CN); Weng Io Ng, Hong Kong (CN)

Correspondence Address: SENNIGER POWERS LEAVITT AND ROEDEL, ONE METROPOLITAN SQUARE, 16TH FLOOR, ST LOUIS, MO, 63102, US

(73) Assignee: World Wide Stationery Manufacturing Company Ltd.

(21) Appl. No.: 09/954,095

(22) Filed: Sep. 17, 2001

(51) Int. Cl. B42F 3/00

(52) U.S. Cl. 402/60

(57) ABSTRACT

Ring binder mechanism with special pronged fasteners secured thereto for fastening it to a binder, the special fastener per se, and a method of making the fasteners involving sheet metal stamping.

### BACKGROUND OF THE INVENTION

This invention relates to the fastening of binder ring mechanisms to binders, encompassing ring mechanisms incorporating fasteners for the purpose, fasteners per se, and a method of making fasteners.

The invention involves improvement in the fastening of binder ring mechanisms to a binder and the fasteners per se over predecessors such as shown in the following U.S. patents:

| U.S. Pat. No. | Date | Title |
|---|---|---|
| 5,160,209 | Nov. 3, 1992 | Fastener Assembly for |
| | | Concealably Fastening a Paper |
| | | Retaining Mechanism to a Binder |
| *5,755,513 | May 26, 1998 | Ring Binder |
| *5,842,807 | Dec. 1, 1998 | Ring Binder |
| 6,019,538 | Feb. 1, 2000 | Clinch Fastener for a Ring Binder |
| *6,033,144 | Mar. 7, 2000 | Ring Binder Mechanism |
| *6,168,339 B1 | Jan. 2, 2001 | Ring Binder |

*Assigned to the assignee of this application.

### BRIEF SUMMARY OF THE INVENTION

Among the several objects of the invention may be noted the provision of improvement in the fastening of binder ring mechanisms to binders (e.g. to cardboard loose-leaf binders); the provision of such fastening making for stronger, more secure attachment of the mechanism to the binders; the provision of fasteners for application to the mechanisms for the enhancement of the securement; and the provision of a superior method of making fasteners.

In general, a ring mechanism of the invention comprises an elongate plate carrying ring components and ring-operating components of the mechanism, said plate having pronged fasteners secured thereto for fastening it to a binder. Each fastener comprises a body generally of cup shape having an end formation constituting one end of the body and a peripheral wall flaring outward from said end formation to the other end of the body, where it is open. Said other end is larger than said one end and has prongs formed integrally therewith projecting from said open end thereof for effecting the fastening of the mechanism to a binder, said end formation being secured to said plate.

The fastener, per se, of the invention comprises a body generally of flaring cup shape with prongs at its open (and larger) end as set forth above.

The method of the invention for making the fasteners generally comprises the punching of fastener bodies generally of cup shape from a sheet of sheet metal, the cup-shaped bodies being integral with the sheet extending in one direction from one face of the sheet, each with an open end at the sheet. This is followed by striking prongs out of the sheet in a pattern around the open end of each of the cup-shaped bodies, the prongs being angled with respect to the sheet in the opposite direction. The pattern is such that each of the cup-shaped bodies remains attached to the sheet at at least one gap in the pattern. Each cup-shaped body is subsequently separated from the sheet at the respective gap.

Other objects and features will be in part apparent and in part pointed out hereinafter.

### BRIEF DESCRIPTION OF THE DRAWINGS

FIG. 1 is a perspective illustrating a three-ring binder mechanism such as may have fasteners of this invention thereon fastened to a binder;

FIG. 2 is a perspective illustrating the ring binder mechanism viewed from the underside thereof;

FIGS. 3A, 3B and 3C are a view in plan of the underside, a side elevation, and a view in plan of FIG. 3B, respectively;

FIG. 4 is a perspective of a fastener per se of the invention;

FIG. 5 is a plan of FIG. 4;

FIGS. 6 and 7 are sections on lines 6-6 and 7-7, respectively, of FIG. 5;

FIGS. 8A and 8B are views illustrating the assembly of the mechanism with a binder;

FIG. 9 is a view in section on a much larger scale than FIG. 8B showing the completed assembly;

FIG. 10 (sheet 4) is a perspective of a modified version of the fastener;

FIG. 11 is a plan of the FIG. 10 fastener;

FIGS. 12 and 13 are sections on lines 12-12 and 13-13, respectively, of FIG. 11;

FIGS. 14 and 15 are views illustrating a method of the invention for making FIG. 10 fasteners, FIG. 15 being generally in section on line 15-15 of FIG. 14 and showing at the right thereof a transverse section of the fastener at the right end of these figures;

FIG. 16 is a perspective of another fastener that may be similarly made; and

FIG. 17 is a plan of the FIG. 16 fastener.

Corresponding reference characters indicate corresponding parts throughout the several views of the drawings.

### DETAILED DESCRIPTION

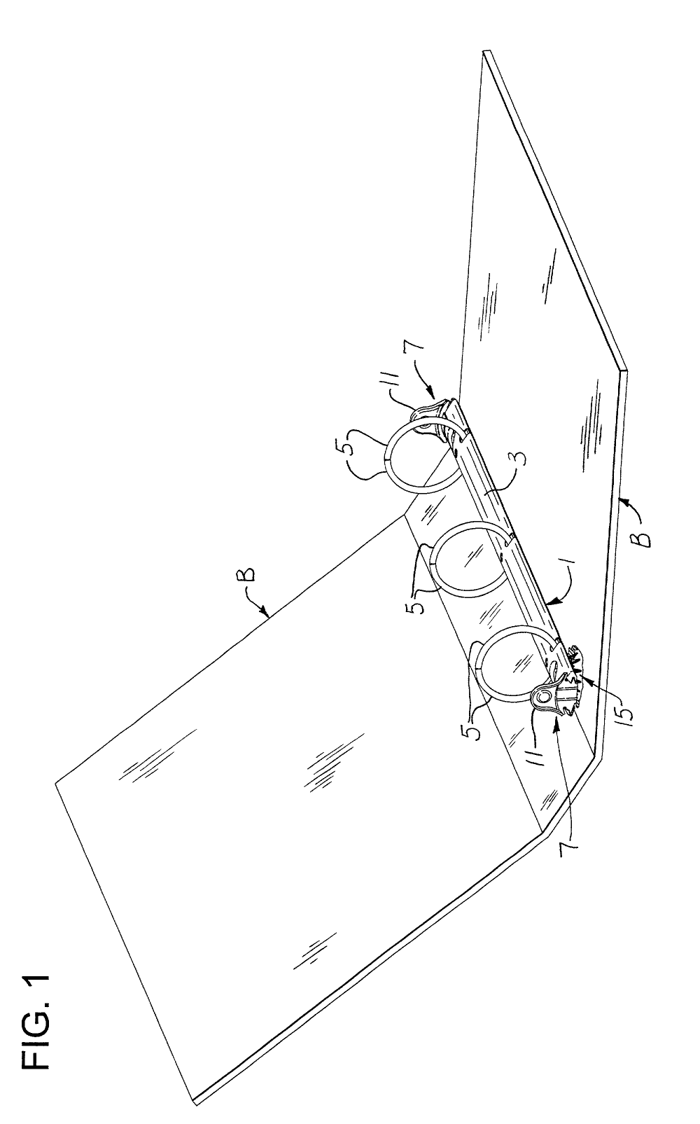

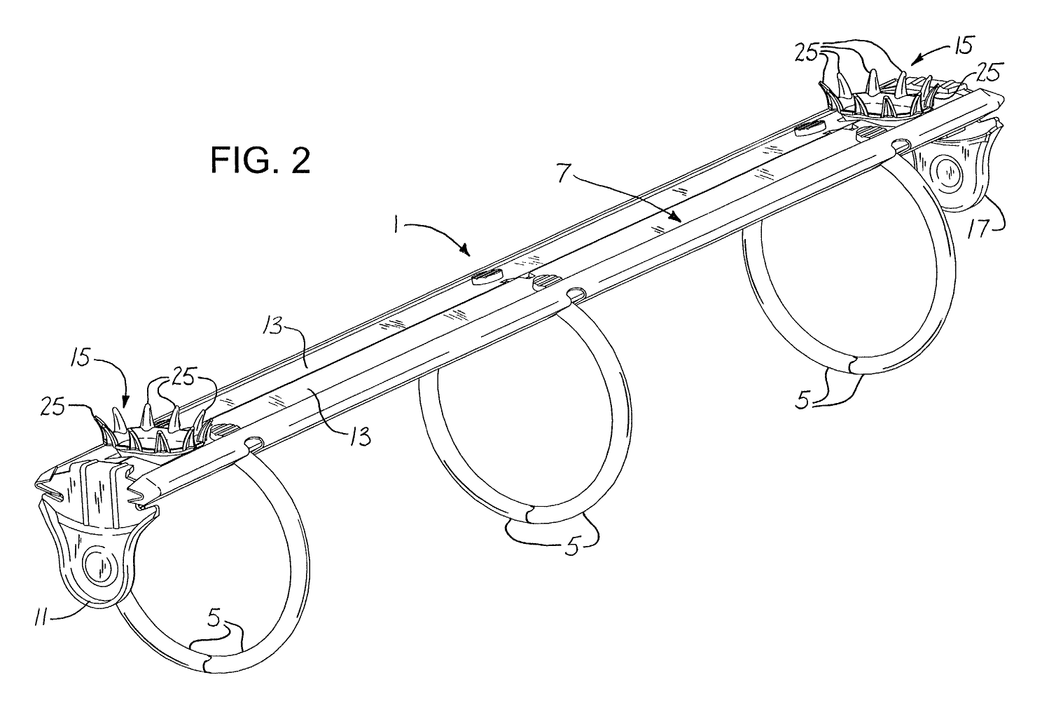

Referring to FIGS. 1, 2, 3A-C, 8A, 8B and 9, a ring mechanism of this invention having fasteners of this invention for fastening the mechanism to a binder is designated in its entirety by the reference numeral 1, a typical binder, designated B, being shown in FIG. 1. The ring mechanism 1 comprises an elongate plate 3 carrying the ring components 5 and ring-operating components 7 of the ring mechanism. In detail, plate 3, generally a sheet metal plate, extends for the length of the mechanism, constituting what may be termed the “spine” thereof. The ring components 5 are half-rings secured at what are in effect inner ends thereof to ring-operating components constituted by elongate pivot plates each designated 9 pivotally carried by plate 3 underneath the latter. The pivot plates are swingable between a ring-closing position and a ring-opening position by ring-operating components constituted by levers 11 (sometimes called “boosters”) pivoted at the ends of plate 3. Plate 3 is arched and has inturned flanges 13 on both sides extending its full length capturing the pivot plates. As thus far described, the mechanism is conventional and well known in the art.

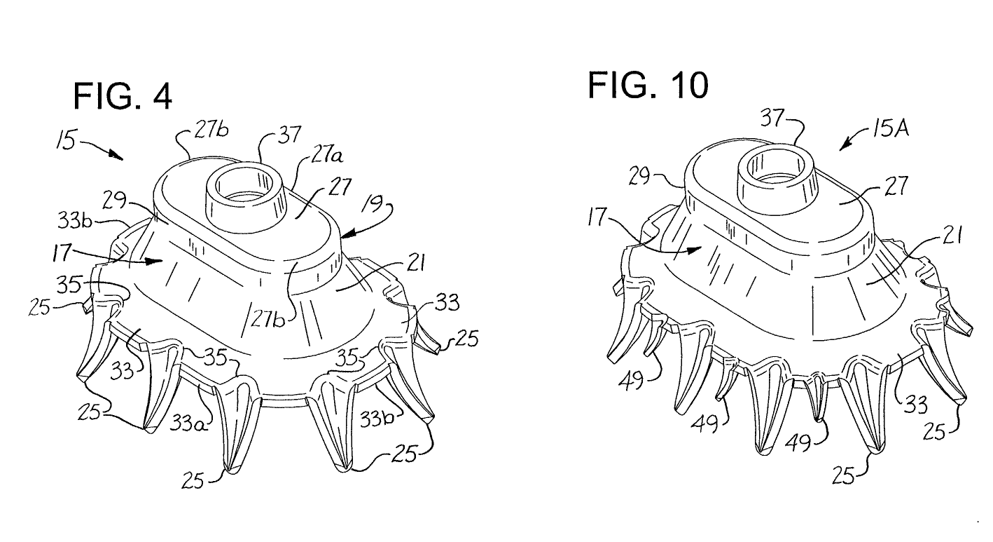

Adjacent each end of the ring mechanism 1 is a pronged fastener of this invention for fastening the mechanism to the binder B. Each of the fasteners, designated 15 in its entirety, comprises a body 17 generally of cup shape having an end formation generally designated 19 constituting one end of the cup-shaped body and a peripheral wall (or skirt) generally designated 21 flaring outward (downward as shown in FIGS. 4, 6, 7 and 9) from said end formation to the other end of the body, where it is open as indicated at 23, the open end at 23 being larger than the end formation. The cup-shaped body 17 has prongs 25 formed integrally therewith projecting from the open end 23 for effecting the fastening of the ring mechanism 1 to a binder B as will be subsequently described. The end formation 19 is secured to plate 3 as will be subsequently described.

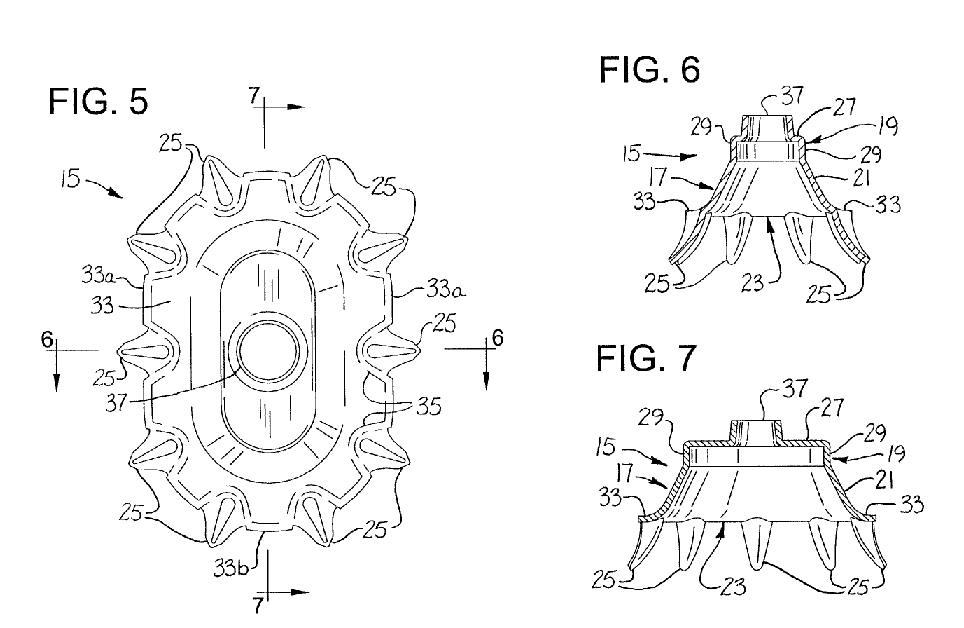

The end formation 19 constituting the said one end of the cup-shaped body 17 is elongate, as readily seen in FIGS. 4 and 5, and the peripheral wall 21, is tapered, being of gradually enlarging transverse cross-section from said one end 19 to said other (open) end 23 of the cup-shaped body. The fastener 15 comprises a one-piece sheet metal stamping, its said one end 19 (end formation 19) comprising a generally flat wall 27, constituting what may be referred to as the proximal end of the cup-shaped body 17, having a narrow surrounding flange 29 depending therefrom at right angles thereto. Wall 27 is generally elliptical, having straight sides 27a and curved (e.g. semi-circular) ends 27b. The peripheral wall 21 of the cup-shaped body 17 accordingly is of gradually enlarging generally elliptical (straight-sided, curved-ended) outline in transverse cross-section from end 19 to the open end 23.

The cup-shaped body 17 is formed with a relatively narrow flange 33 extending outwardly from the tapered peripheral wall 21 at the open end 23 of the body. The prongs 25 are rooted in this flange as indicated at 35, spaced at intervals around said open end 23, being of curved formation curving down and away therefrom as viewed in FIGS. 4, 6 and 7 (flaring away from the open end). As appears in FIG. 5, there are ten prongs, three on each side 33a and two on each curved end 33b of the peripheral flange 33 (which partakes of the generally elliptical shape of the open end 23 of the cup-shaped body 17).

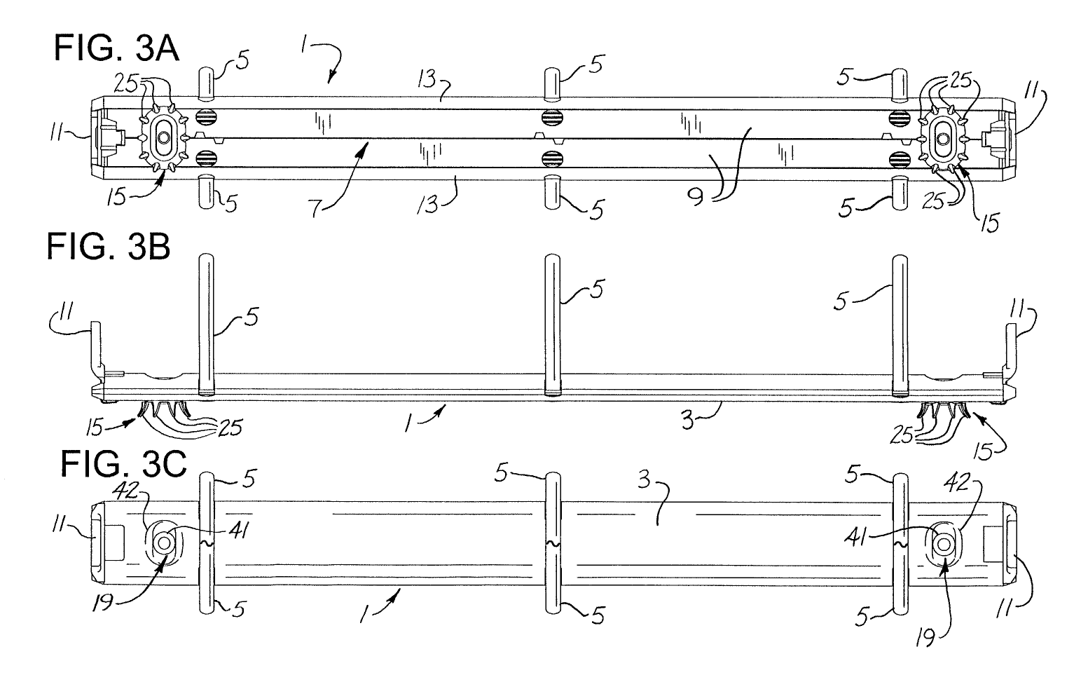

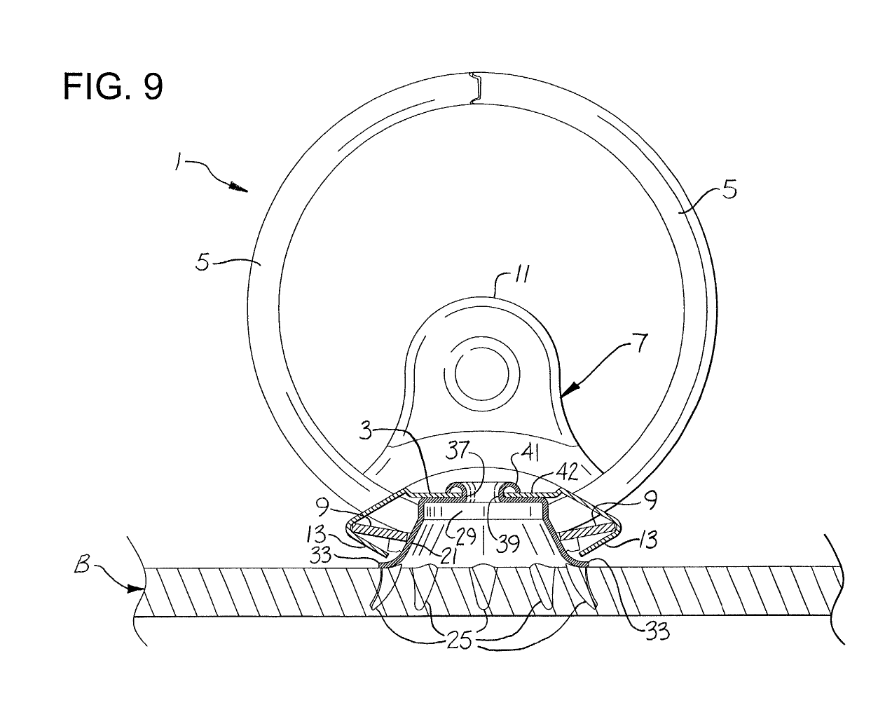

Each of the two fasteners 17 of the ring mechanism 1 is secured on the inside of the plate 3 adjacent the respective end of the plate with its end wall 27 engaging the plate and secured thereto by a rivet 37 formed integrally with the end wall 27. The cup-shaped body 17 is initially formed with an integral cylindrical tubular stem constituting the rivet at the center of end wall 27, the stem extending through a rivet hole 39 in the plate 3 and its end swaged over on the plate as indicated at 41 (FIGS. 3C and 9) in a depression 42 in plate 3. Each fastener 17 is secured to the plate 3 at the respective end of the plate with the end wall 27, in its elongate (generally elliptic) form, extending transversely with respect to the plate. Thus, each of fasteners 15 is secured to the plate 3 closely adjacent the lever 11 at the respective end of the plate, as is advantageous, with its entire set of prongs 25 (including those on the side of the end wall 27 away from the lever) relatively closely adjacent the lever 11.

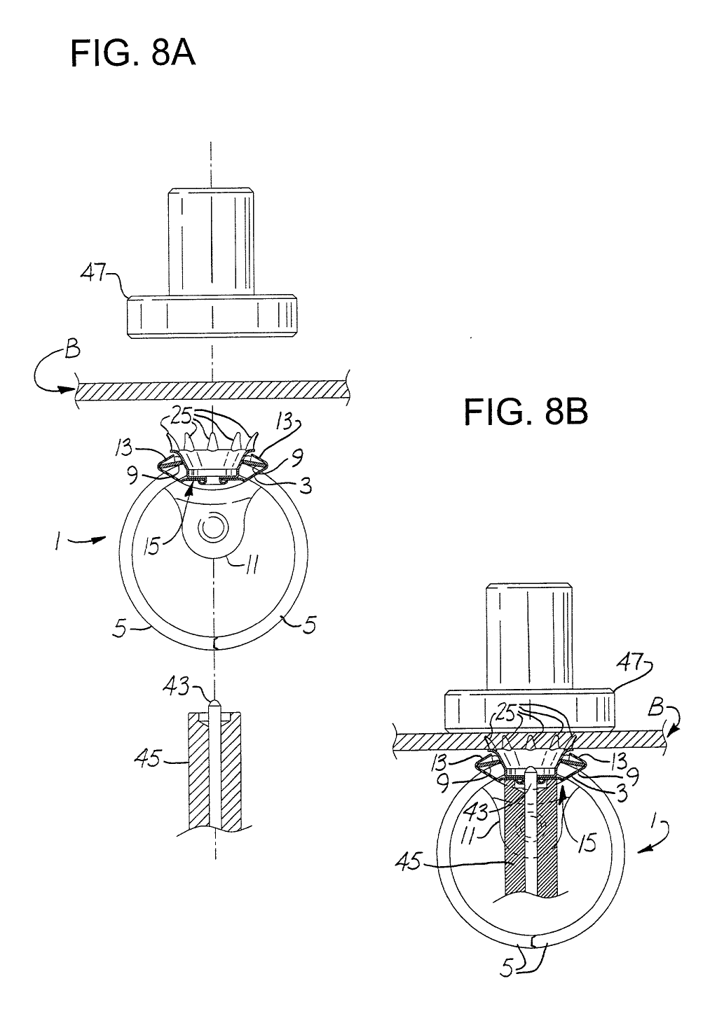

The ring mechanism 1, with the fasteners 15 secured thereto, may be fastened to a binder B (e.g. one comprising cardboard) as shown in FIGS. 8A, 8B and 9. Referring first to FIG. 8A, the ring mechanism 1 is shown in prongs-up position below binder B for reception in a rivet hole 39 in plate 3 of the ring mechanism of a locating pin 43 extending up from an anvil 45; FIG. 8A also shows a pressure head 47 above the binder, and FIG. 8B shows the ring mechanism 1 impaled on pin 43, backed up by the anvil 45, and the presser head 47 down on the binder B, resulting in the penetration of the prongs 25 into the binder, thus effecting the fastening of the ring mechanism 1 to the binder as shown in enlarged manner in FIG. 9.

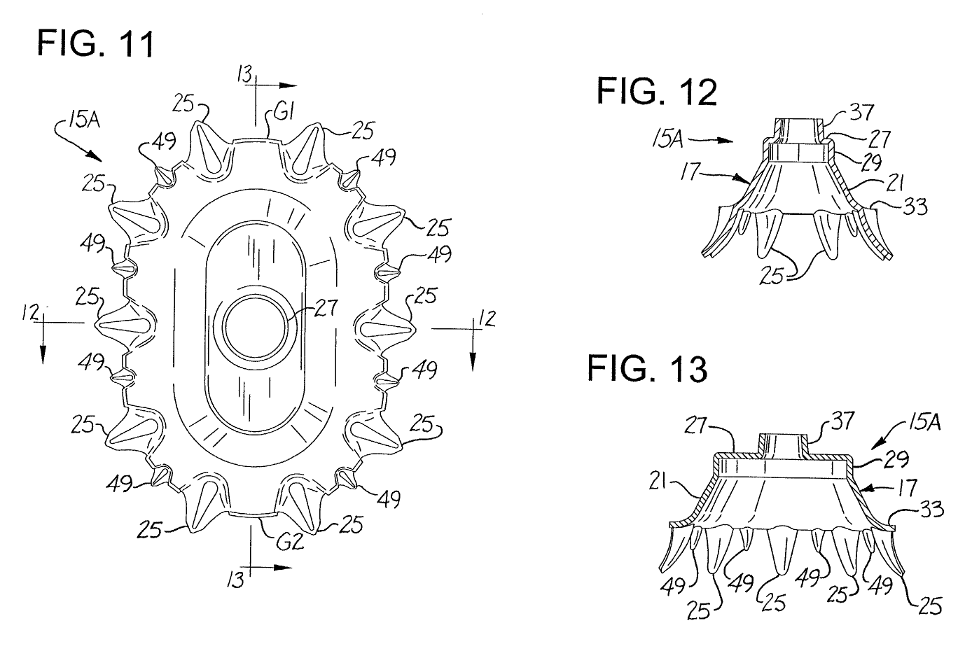

FIGS. 10-13 show a modification of the fastener for the most part like fastener 15 and denoted 15A in its entirety, differing primarily from fastener 15 in having relatively small teeth 49 formed integrally on flange 33 in the gaps between the five prongs on one side and the five prongs on the other side (thus having four teeth 49 on each side). Of significance is the absence of a tooth in the gap between the two prongs at each end of the flange (the reason therefor will become apparent later).

The flaring (tapering) configuration of the peripheral wall 21 (as sharply distinguished from a non-flaring or non-tapered, e.g. cylindric, configuration) is especially noteworthy in that it provides for effective transfer of force to the prongs so that they can be driven deep into the binder without requiring a relatively large rivet hole in the plate 3. Also noteworthy is the elongated (generally elliptical) shape of fasteners 15, enabling their affixation to the plate 3 with all prongs 25 in close proximity to the ends of the ring mechanism (describable to keep portions of the binder adjacent the ends of the mechanism affixed thereto). And also noteworthy is the provision of the flange 33 at the open end 23 of the cup-shaped body 17, said flange (in addition to being what is in effect a base for prongs 25) acting as a limit stop engageable with the binder B on the pressing of the prongs into the binder (FIG. 8B) to limit the penetration so as to prevent the prongs from going through the binder.

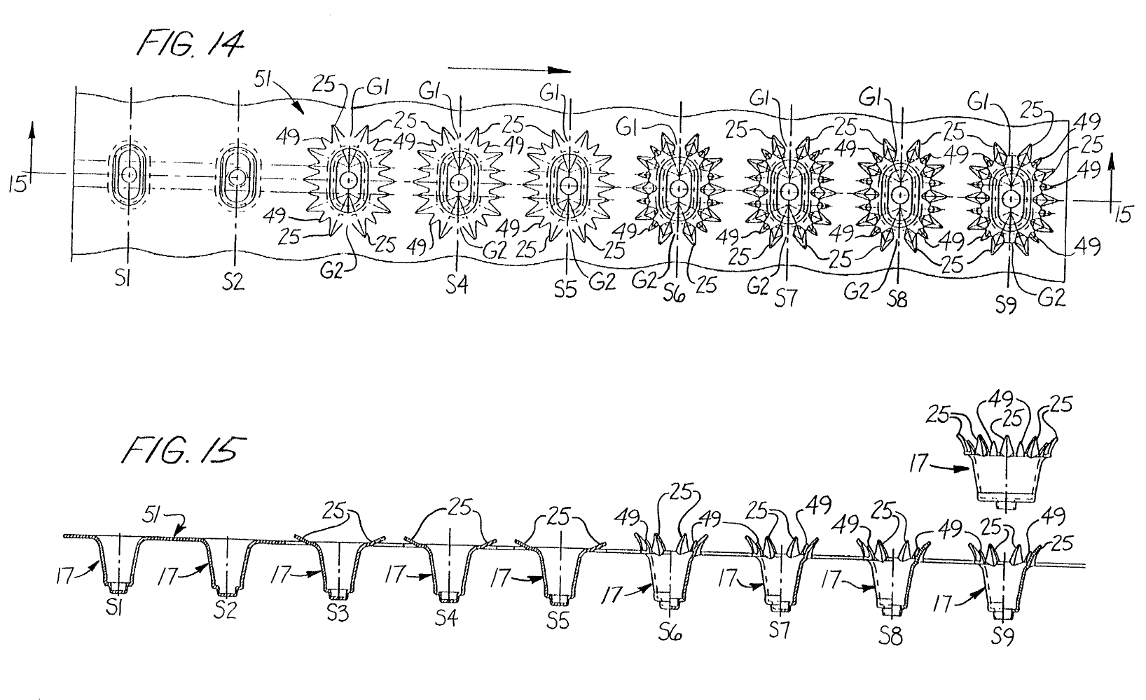

FIGS. 14 and 15 illustrate a method of this invention for making the fasteners 15A with the teeth 49, the principles of this method also being applicable to making of fasteners 15 and others, comprising punching (stamping out) cup-shaped bodies 17A from a sheet 51 of sheet metal (specifically, e.g. 0.028 inch thickness steel), the cup-shaped bodies 17A being integral with the sheet extending in one direction from one face of the sheet, each with its open end 23 at the sheet. As shown in FIGS. 14 and 15, each punched-out body 17A has the flaring (tapered) peripheral wall 21 and the elliptical wall 27 with the rivet hole 39. As shown in FIG. 15, the cup-shaped bodies 17 extend down from below the underside (bottom face) of the sheet 51 and the tapered peripheral wall 21 extends down from the sheet. Prongs 25 and teeth 49 are struck out of the sheet in the pattern of FIG. 10 around the open ends 23 of the bodies, the prongs and the teeth being angled in the opposite direction (up as appears in FIG. 15) with respect to the sheet 51. The pattern is such that the bodies, with the upstruck prongs 25 and teeth 49 are separated (detached) from the sheet at the prongs and teeth and also between the prongs and the teeth so as to form the flange 33 around the open end 23 of each body with the prongs and teeth rooted in the flange 33, but remain attached to the sheet 51 at at least one gap in the pattern. Preferably, at this stage, each body 17 remains attached to the sheet at two “toothless” gaps as indicated at G1 and G2, each “toothless” gap being between the two prongs at the respective end of the generally elliptical open end 23 of the body. At first, the striking up of the prongs and teeth is only partial as indicated at the positions indicated at S3, S4, S5 in FIG. 15, the striking up being completed at the position indicated at S6. Finally, each cup-shaped body 17 with the prongs and teeth rooted in flange 33 is separated from the sheet at the gaps G1 and G2.

The sheet 51 may be a strip of sheet metal (the term “sheet” being considered as encompassing a “strip”), fed forward intermittently in steps such as indicated at in FIGS. 14 and 15 in a feed path with a dwell at each of stations indicated at S1-S9. The punching of the strip to form the cup-shaped bodies 17 may be carried out by a suitable punch press at station S1, the preliminary up-striking of the prongs 25 and teeth 49 may be carried out by suitable tooling at station S3, the final up-striking by suitable tooling at station S6 and the final separation by suitable tooling at station S9 (as shown).

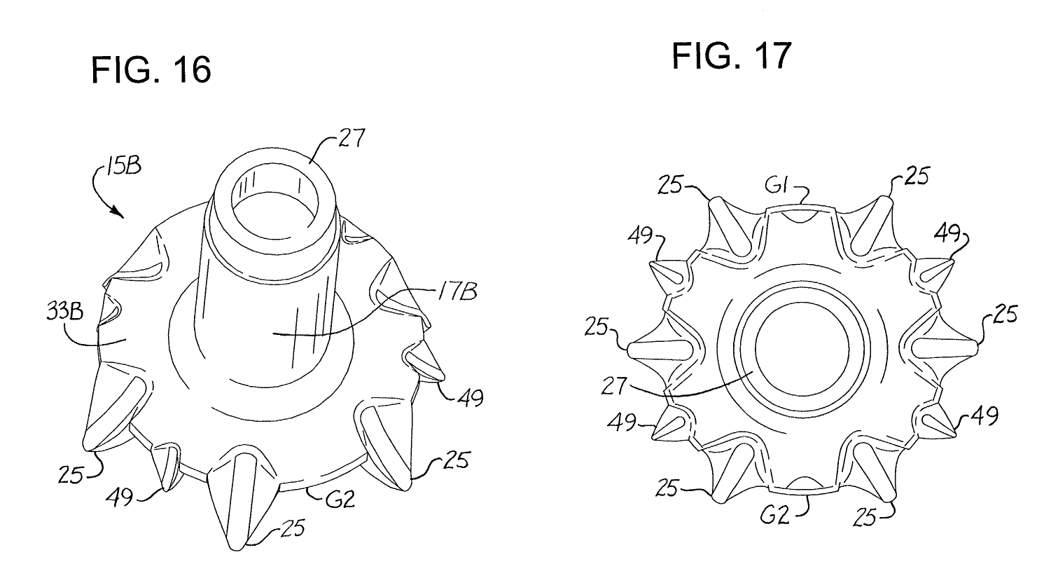

FIGS. 16 and 17 illustrate a fastener 15B having a flange 33B and prongs 25 and teeth 49 rooted in the flange similarly to FIG. 10, but with a cylindric cup-shaped body 17B instead of a tapered body, which may be made by the above-described method. Note the absence of teeth in gaps GI and G2. While this may not partake of the advantage of the tapered peripheral wall as heretofore described of having a broader base for more prongs for enhanced fastening of the ring mechanism to the binder, it partakes of the teeth plus prongs characteristic, the gap principle, and the susceptibility of manufacture akin to that illustrated in FIGS. 14 and 15.

In view of the above, it will be seen that the several objects of the invention are achieved and other advantageous results attained.

As various changes could be made in the above constructions and method without departing from the scope of the invention, it is intended that all matter contained in the above description and shown in the accompanying drawings shall be interpreted as illustrative and not in a limiting sense.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

What is claimed is:

1. A ring mechanism for a loose-leaf binder comprising an elongate plate carrying ring components and ring-operating components of the mechanism, said plate having pronged fasteners secured thereto for fastening it to a binder, each fastener comprising a body generally of cup shape having an end formation constituting one end of the body and a peripheral wall flaring outward from said end formation to the other end of the body, where it is open, said other end being larger than said one end and having prongs formed integrally with said body projecting from said open end thereof for effecting the fastening of the mechanism to a binder, said end formation being secured to said plate.

2. A ring mechanism as set forth in claim 1 wherein said one end is of elongate form and said peripheral wall is of gradually enlarging transverse cross-section from said one end to said other end.

3. A ring mechanism as set forth in claim 2 wherein said one end is generally elliptical and said peripheral wall is of gradually enlarging elliptical outline in transverse cross-section from said one end to said other end.

4. A ring mechanism as set forth in claim 3 wherein said one end has straight sides and curved ends and said peripheral wall likewise has straight sides and curved ends.

5. A ring mechanism as set forth in claim 1 wherein each fastener comprises a one-piece sheet metal stamping, said one end of the body comprising an end wall, the latter being secured to said plate.

6. A ring mechanism as set forth in claim 5 wherein the end wall at said one end of the body engages said plate and is secured thereto by having a rivet formed integrally therewith extending through a rivet hole in the plate and swaged over on the plate.

7. A ring mechanism as set forth in claim 1 wherein said cup-shaped body has a flange extending outwardly from said peripheral wall at said other end of the cup-shaped body, said prongs being rooted in said flange spaced at intervals therearound and flaring away from said other end of the cup-shaped body.

8. A ring mechanism as set forth in claim 2 having a fastener adjacent each end of the plate, each fastener being secured to the plate at said one end thereof with said one end, in its elongate form, extending transversely with respect to the plate.

9. A ring mechanism as set forth in claim 3 having a fastener adjacent each end of the plate, each fastener being secured to the plate at said generally elliptical one end thereof with the elliptical one end thereof extending transversely with respect to the plate.

10. A ring mechanism for a loose-leaf binder comprising an elongate plate carrying ring components and ring-operating components of the mechanism, said plate having pronged fasteners secured thereto for fastening it to a binder, each fastener being a one-piece sheet metal stamping comprising a body generally of cup shape having a generally elliptical end wall constituting one end of the body and a peripheral wall flaring outwardly from said end wall to the other end of the body where it is open, said peripheral wall being of gradually enlarging elliptical outline in transverse cross-section from said one end of the body to said other end constituting the open end of the body, said open end being larger than said one end, said body having a flange extending outwardly from said peripheral wall at said open end, prongs integral with the body rooted in the flange spaced at intervals therearound and flaring away from said open end, said end wall engaging said plate and being secured thereto extending transversely of the plate by a rivet formed integrally with said end wall extending through a rivet hole in the plate and swaged down on the plate.

11. A fastener for application to a ring mechanism for a binder for fastening the ring mechanism to a binder, said fastener comprising a body generally of cup shape having an end formation constituting one end of the body and a peripheral wall flaring outward from said end formation to the other end of the body, where it is open, said other end being larger than said one end and having prongs formed integrally with said body projecting from said open end thereof for effecting the fastening of the mechanism to a binder.

12. A fastener as set forth in claim 11 wherein said one end is of elongate form and said peripheral wall is of gradually enlarging transverse cross-section from said one end to said other end.

13. A fastener as set forth in claim 12 wherein said one end is generally elliptical and said peripheral wall is of gradually enlarging elliptical outline in transverse cross-section from said one end to said other end.

14. A fastener as set forth in claim 13 wherein said one end has straight sides and curved ends and said peripheral wall likewise has straight sides and curved ends.

15. A fastener as set forth in claim 11 comprising a one-piece sheet metal stamping, said one end of the body comprising an end wall.

16. A fastener as set forth in claim 15 wherein said end wall has a rivet formed integrally therewith for securing it to a ring mechanism.

17. A fastener as set forth in claim 11 wherein said cup-shaped body has a flange extending outwardly from said peripheral wall at said other end of the cup-shaped body, said prongs being rooted in said flange spaced at intervals therearound and flaring away from said other end of the cup-shaped body.

18. A fastener for application to a ring mechanism for a binder for fastening the ring mechanism to a binder, said fastener being a one-piece sheet metal stamping comprising a body generally of cup shape having a generally elliptical end wall constituting one end of the body and a peripheral wall flaring outwardly from said end wall to the other end of the body where it is open, said peripheral wall being of gradually enlarging elliptical outline in transverse cross-section from said one end of the body to said other end constituting the open end of the body, said open end being larger than said one end, said body having a flange extending outwardly from said peripheral wall at said open end, prongs integral with the body rooted in the flange spaced at intervals therearound and flaring away from said open end,

19. A fastener as set forth in claim 18 wherein said end wall has a rivet formed integrally therewith for securing it to a ring mechanism.

20. A fastener as set forth in claim 17 having teeth rooted in the flange interspersed between prongs.

21. A fastener for application to a ring mechanism for a binder for fastening the ring mechanism to a binder, said fastener comprising a sheet metal body generally of cup shape having an end formation constituting one end of thereof and a peripheral wall extending from said end wall to the other end of the body where it is open, said peripheral wall having a flange extending outwardly therefrom at its said other (and open) end, prongs formed integrally with said flange rooted in said flange spaced at intervals therearound having gaps therebetween and flaring away from said open end, and teeth rooted in the flange interspersed between prongs.

22. A fastener as set forth in claim 21 wherein there is at least one toothless gap between two adjacent prongs.

23. The method of making fasteners for application to ring mechanisms for binders for fastening the mechanisms to the binders, said method comprising
punching fastener bodies generally of cup shape from a sheet of sheet metal, the cup-shaped bodies being integral with the sheet extending in one direction from one face of the sheet each with an open end at the sheet;
striking prongs out of the sheet in a pattern around the open end of each of the cup-shaped bodies, the prongs being angled with respect to the sheet in the opposite direction;
the pattern being such that each of the cup-shaped bodies remains attached to the sheet at at least one gap in the pattern; and
subsequently separating each cup-shaped body from the sheet at the respective gap.

24. The method of claim 23 wherein the punching forms each cup-shaped body with a taper from its said open end to its other end.

25. The method of claim 24 wherein the punching forms each cup-shaped body to be of generally elliptical outline in transverse cross-section.

26. The method of claim 25 wherein the punching forms each cup-shaped body to have straight sides and curved ends.

27. The method of claim 23 wherein the striking of the prongs out of the sheet comprises an initial partial striking and a subsequent final striking.

28. The method of claim 23 wherein the sheet comprises a strip, the strip being fed forward intermittently in step through a plurality of stations, with a dwell at each station, the punching being carried out at a first station during a dwell, the striking out of the prongs being carried out during a dwell at stations downstream from the first.

29. The method of claim 28 wherein the striking out of the prongs comprises an initial partial strike-out at a station downstream from the first and a subsequent final strike-out at a station downstream from the second.

30. The method of claim 28 further comprising striking teeth out of the sheet in less than all gaps between prongs leaving each body attached to the sheet thereat, and separating each body from the strip thereat.

31. The method of claim 30 wherein the striking out of the prongs comprises an initial partial strike-out at a station downstream from the first and a subsequent final strike-out at a station downstream from the second.

32. The method of claim 31 wherein the teeth are struck out of the sheet at the station where the initial strike-out of the prongs takes place.

33. The method of claim 28 wherein the punching forms each cup-shaped body with a taper from its said open end to its other end.

34. The method of claim 33 wherein the punching forms each cup-shaped body to be of generally elliptical outline in transverse cross-section.

35. The method of claim 34 wherein the punching forms each cup-shaped body to have straight sides and curved ends.
